(19) United States
(12) Patent Application Publication
(10) Pub. No.: US 2015/0096057 A1
(43) Pub. Date: Apr. 2, 2015

(54) Device Robustness Framework

(71) Applicant: Sonic IP, Inc., Santa Clara, CA (US)

(72) Inventor: Michael G. Kiefer, Lake Havasu City, AZ (US)

(73) Assignee: Sonic IP, Inc., Santa Clara, CA (US)

(21) Appl. No.: 14/042,532

(22) Filed: Sep. 30, 2013

(51) Int. Cl. H04L 29/06

(52) U.S. Cl. CPC H04L 63/10; H04L 63/08
USPC 726/29

(57) ABSTRACT

Systems and methods for utilizing a robustness framework to restrict access to digital content distributed via a network in accordance with embodiments of the invention are disclosed. In one embodiment, restricting access to digital content includes loading device robustness information, where the device robustness information includes a device robustness level defined using a set of robustness rules, loading at least one digital rights management (DRM) certificate, where the at least one DRM certificate is utilized to authenticate the device to a DRM server, requesting playback of the content from a content store, where the content store is configured to store the content in at least one content distribution server, receiving the content from the at least one content distribution server upon a verification that the device robustness satisfies a threshold robustness by a computing system, and accessing the received content utilizing the at least one DRM certificate.

### FIELD OF THE INVENTION

The present invention generally relates to Digital Rights Management (DRM) systems and more specifically to DRM systems capable of dynamically evaluating device robustness levels using a robustness framework.

### BACKGROUND

Modern playback devices are equipped to download and play digital content including (but not limited to) digital video and audio files. Content providers can provide digital content to service providers (i.e. content stores) for distribution to consumers. In many content distribution systems, the content stores can utilize digital rights management (DRM) schemes to protect against piracy and to control usage rights such as viewing, printing, and sharing. Although various DRM schemes can be utilized, robustness of a device that resists or prevents attempts to compromise the DRM typically depends on the device configurations determined by the device manufacturer. Further, the playback capabilities and the DRM are implemented on playback devices using software. Therefore, the same software running on different devices may have different levels of robustness to attacks designed to gain unauthorized access to content. So-called robustness rules can be defined to assess the level of security achieved by a playback device and/or required for a playback device to receive content.

### SUMMARY OF THE INVENTION

Systems and methods for utilizing a robustness framework to restrict access to digital content distributed via a network in accordance with embodiments of the invention are disclosed. In one embodiment, restricting access to digital content utilizing a set of robustness rules includes loading device robustness information, where the device robustness information includes a device robustness level defined using a set of robustness rules, loading at least one digital rights management (DRM) certificate, where the at least one DRM certificate is utilized to authenticate the device to a DRM server, requesting playback of the content from a content store, where the content store is configured to store the content in at least one content distribution server, receiving the content from the at least one content distribution server upon a verification that the device robustness satisfies a threshold robustness by a computing system, where the threshold robustness is predetermined by a content provider, and accessing the received content utilizing the at least one DRM certificate.

In a further embodiment, the device robustness level is verified when the device robustness level is greater than the threshold robustness.

In another embodiment, the device robustness level is verified when the device robustness level is equal to the threshold robustness.

In a still further embodiment, the device robustness level is not verified when the device robustness level is less than the threshold robustness.

In still another embodiment, the computing device that verifies that the device robustness level satisfies the predetermined threshold robustness is a remote server.

In a yet further embodiment, the computing device that verifies that the device robustness level satisfies the predetermined threshold robustness is the playback device.

In yet another embodiment, the content has an associated license that is embedded with the robustness threshold.

In a further embodiment again, loading at least one digital rights management (DRM) certificate further includes the DRM server transmitting the at least one DRM certificate to the playback device at registration of the device with the DRM server.

In another embodiment again, the device robustness information is stored in an encrypted memory on the playback device.

In a further additional embodiment, the memory is encrypted using a device protection key generated using device match data where the device match data can include device characteristics.

In another additional embodiment, the set of robustness rules is defined utilizing Federal Information Processing Standards.

In a still yet further embodiment, a playback device includes a processor, and a memory containing a client application that configures the processor to: load device robustness information, where the device robustness information includes a device robustness level defined using a set of robustness rules, load at least one digital rights management (DRM) certificate, where the at least one DRM certificate is utilized to authenticate the device to a DRM server, request playback of the content from a content store, where the content store is configured to store the content in at least one content distribution server, receive the content from the at least one content distribution server upon a verification that the device robustness satisfies a threshold robustness by a computing system, where the threshold robustness is predetermined by a content provider, and access the received content utilizing the at least one DRM certificate.

In still yet another embodiment, the device robustness level is verified when the device robustness level is greater than the threshold robustness.

In a still further embodiment again, the device robustness level is verified when the device robustness level is equal to the threshold robustness.

In still another embodiment again, the device robustness level is not verified when the device robustness level is less than the threshold robustness.

In a still further additional embodiment, the computing device that verifies that the device robustness level satisfies the predetermined threshold robustness is a remote server.

In still another additional embodiment, the computing device that verifies that the device robustness level satisfies the predetermined threshold robustness is the playback device.

In a yet further embodiment again, the content has an associated license that is embedded with the robustness threshold.

In yet another embodiment again, the loading at least one digital rights management (DRM) certificate also includes the DRM server transmitting the at least one DRM certificate to the playback device at registration of the device with the DRM server.

In a yet further additional embodiment, the device robustness information is stored in an encrypted memory on the playback device.

In yet another additional embodiment, the memory is encrypted using a device protection key generated using device match data where the device match data can include device characteristics.

In a further additional embodiment again, the set of robustness rules is defined utilizing Federal Information Processing Standards.

In another additional embodiment again, a machine readable medium containing processor instructions, where execution of the instructions by a processor causes the processor to perform a process including loading device robustness information, where the device robustness information includes a device robustness level defined using a set of robustness rules, loading at least one digital rights management (DRM) certificate, where the at least one DRM certificate is utilized to authenticate the device to a DRM server, requesting playback of the content from a content store, where the content store is configured to store the content in at least one content distribution server, receiving the content from the at least one content distribution server upon a verification that the device robustness satisfies a threshold robustness by a computing system, where the threshold robustness is predetermined by a content provider, and accessing the received content utilizing the at least one DRM certificate.

### BRIEF DESCRIPTION OF THE DRAWINGS

FIG. 1 is a system diagram of a device robustness framework in accordance with an embodiment of the invention.

FIG. 2 illustrates a content store server in accordance with an embodiment of the invention.

FIG. 3 illustrates a content distribution server in accordance with an embodiment of the invention.

FIG. 4 illustrates a playback device in accordance with an embodiment of the invention.

FIG. 5 is a flow chart illustrating a process for verifying robustness of a playback device in accordance with an embodiment of the invention.

FIG. 6 is a flow chart illustrating a process for setting device robustness information to encrypted memory in accordance with an embodiment of the invention.

FIG. 7 is a flow chart illustrating a process for embedding threshold robustness levels in a content license in accordance with an embodiment of the invention.

FIG. 8 is a diagram illustrating communication between a playback device and a content store server in verifying device robustness at a content store server in accordance with an embodiment of the invention.

FIG. 9 is a flow chart illustrating a process for verifying playback device robustness at a content store server in accordance with an embodiment of the invention.

FIG. 10 is a diagram illustrating communication between a playback device and a content store server in verifying device robustness at a playback device in accordance with an embodiment of the invention.

FIG. 11 is a flow chart illustrating a process for verifying playback device robustness at a playback device in accordance with an embodiment of the invention.

### DETAILED DESCRIPTION OF THE DRAWINGS

Turning now to the drawings, systems and methods for utilizing a robustness framework to restrict access to digital content distributed via a network in accordance with embodiments of the invention are illustrated. In many embodiments, the content provider sets a robustness threshold that defines a level of security a playback device should achieve in order to gain access to the content. In several embodiments, a device robustness level is defined for a playback device based upon a set of robustness rules where the robustness rules outline security characteristics indicative of robustness to outside attacks intended to gain unauthorized access to encrypted content and/or obtain encryption keys utilized within a Digital Rights Management (DRM) system. In various embodiments, the device robustness is first verified before the playback device is granted access to the requested content. Device robustness verification can occur at the playback device or at the content store server as further discussed below. In some embodiments, the device robustness framework can be part of a DRM system including (but not limited to) the DRM systems described in U.S. patent application Ser. No. 13/339,315, entitled “Binding of Cryptographic Content using Unique Device Characteristics with Server Heuristics”, filed Dec. 28, 2011, the disclosure of which is incorporated by reference herein in its entirety.

To combat unknown device security levels, some content providers may require that devices are “certified” indicating that a device meets and/or exceeds threshold robustness levels defined using predetermined robustness rules. Such robustness rules can utilize industry standards including (but not limited to) the Federal Information Processing Standards (FIPS) 140-2 published by the Information Technology Laboratory of the National Institute of Standards and Technology. However, robustness rules generally lack standardization and each device may have a different solution to pass a particular robustness rule. Further, multiple device models may have implemented some of the robustness rules while other models have not. In various embodiments, the device may not be certified but still request access to content using a player pack that can be downloaded and installed on a playback device. In such embodiments, the device robustness level typically is not known beforehand and the device may only be allowed access to content requiring a lower threshold robustness.

In many embodiments, the threshold robustness can be marked on the content offering to alert potential end users of the device robustness required to access the content. Also, the content may require a license (encrypted block of data that may include encryption keys) to access the content where the threshold robustness can be embedded in the license. In several embodiments, the threshold robustness can be dynamically changed in order to either restrict or allow greater access to the content in the marketplace. When appropriate, the content provider can work in connection with the content store to determine the appropriate robustness threshold level. Content distribution systems that restrict access to content utilizing a robustness framework in accordance with embodiments of the invention are discussed further below.

### Content Distribution Systems

Content distribution systems in accordance with many embodiments of the invention typically include playback devices that can purchase the right to access content stored on content distribution servers via a content store. A content store can be a virtual marketplace for presenting available digital content to end users. Although described as a store, users may subscribe to a service and can request content via a content store server without making a purchase. In many instances, a separate content distribution network stores and transmits the content to the playback device of the end user. Further, DRM servers can be utilized to authenticate playback devices and a robustness framework can be utilized to restrict content access to devices that meet a predetermined robustness threshold. Playback devices and servers can communicate and exchange information over a variety of networks including (but not limited to) the Internet.

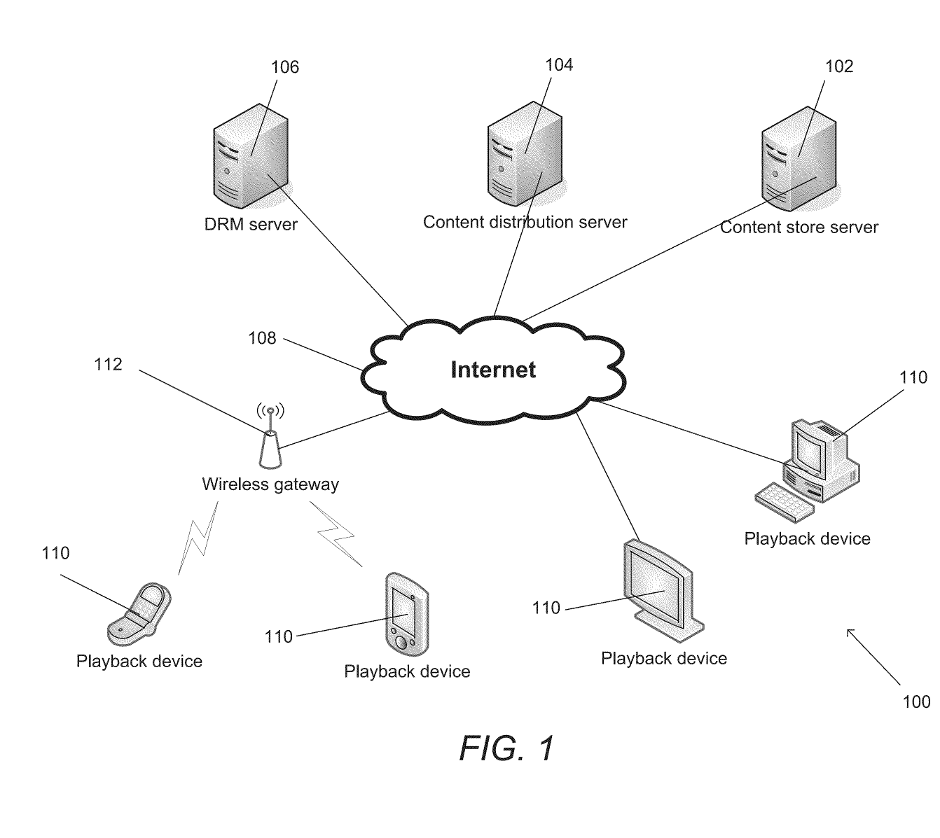

A content distribution system in accordance with an embodiment of the invention is illustrated in FIG. 1. The system 100 includes a number of playback devices 110 that can be connected to a content store server 102, content distribution server 104, and a DRM server 106 via the Internet 108. In various embodiments, some playback devices 110 communicate wirelessly with a cellular data network 112 (i.e. wireless gateway) to connect to the Internet 108. The content store server 102, content distribution server 104, and DRM server 106 can also connect to each other via the Internet 108 utilizing network interfaces as further discussed below. Although specific content distribution systems for restricting access to content utilizing a robustness framework are discussed above with respect to FIG. 1, any of a variety of content distribution systems for restricting access to content with a robustness framework as appropriate to the requirements of a specific application can be utilized in accordance with embodiments of the invention. Configurations of servers and playback devices in accordance with embodiments of the invention are discussed further below.

### Server and Playback Device Configurations

Content store servers in accordance with many embodiments of the invention can load a content store application as machine readable instructions from memory or other storage. The content store application can configure the content store server to receive content from a content provider for storage in one or more content distribution servers. The content store application can also configure the processor to create an interface for users to request available content. Further, the content store server can be configured by the content store application to utilize DRM schemes in distribution of content.

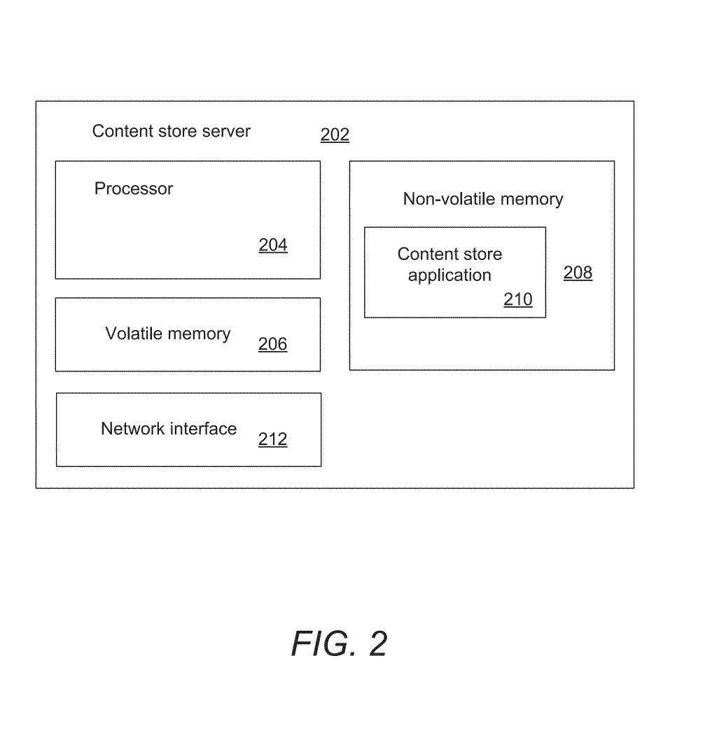

A content store server in accordance with an embodiment of the invention is illustrated in FIG. 2. The content store server 202 includes a processor 204, volatile memory 206, and a non-volatile memory 208 that includes a content store application 210. The content store application 210 is utilized to configure the processor 204 to perform various functions including (but not limited to) presenting available content and processing content offerings with robustness thresholds as further discussed below. In many embodiments, the content store server 202 includes a network interface to communicate with other servers and playback devices connected via the Internet. In the illustrated embodiment, the non-volatile memory 208 is a machine readable media that is utilized to store the machine readable instructions that configure the processor 204.

Content distribution servers can store and distribute digital content. In many embodiments, a content distribution server can be part of a content distribution network (CDN). Typically, a CDN is a large distributed system of servers that are strategically located across the Internet to provide high bandwidth/low latency connections between at least one server in the CDN and a user. The goal of a CDN is to distribute content to an end user with high availability and high performance.

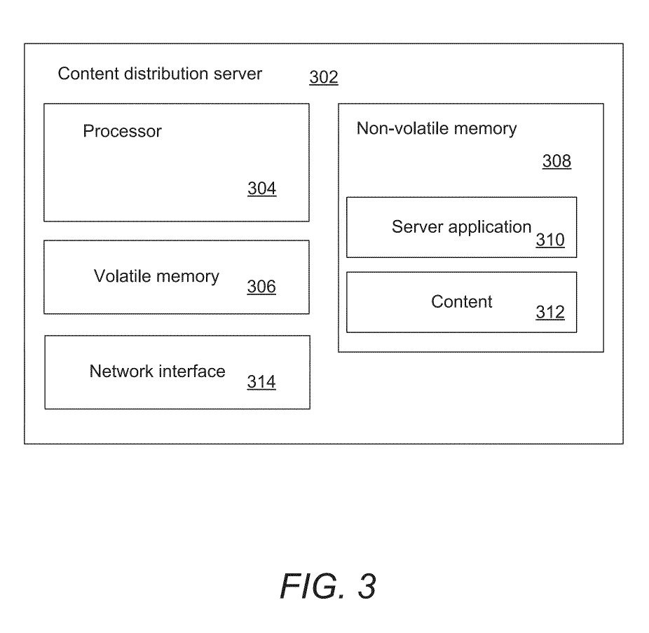

A content distribution server in accordance with an embodiment of the invention is illustrated in FIG. 3. The content distribution server 302 includes a processor 304, volatile memory 306, and non-volatile memory 308 that includes a server application 310 and digital content 312. In many embodiments, the content distribution server application 310 configures the processor 304 to store and distribute content via the network interface 314 over the Internet to a playback device. In various embodiments, the network interface can be utilized to communicate with other servers and playback devices. In several embodiments, the content can be encrypted using one or more encryption keys where the encryption keys can be stored on a DRM server. The DRM server can use the encryption keys to generate a content license specific to a playback device, user, and/or session in real time in response to a content request.

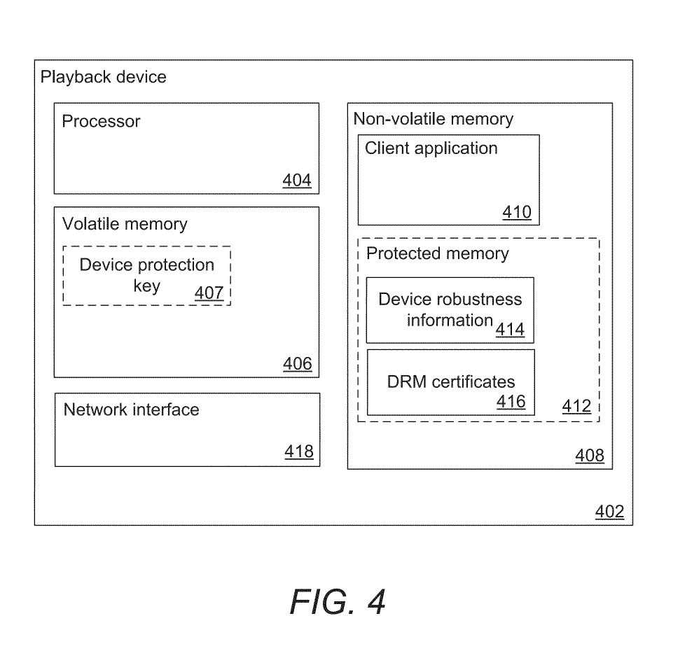

Playback devices can be used to download and playback content. A playback device in accordance with an embodiment of the invention is illustrated in FIG. 4. The playback device 402 includes a processor 404 and a volatile memory 406 that may include a device protection key 407 generated using so-called device match data. Device match data can include device characteristics and the representations of device characteristics in different literal forms. In many embodiments of the invention, device match data is collected by a playback device at the time of registration with a DRM server and then utilized to identify the playback device during subsequent transactions with the DRM system. In a number of embodiments of the invention, a device protection key is generated by a playback device when the device registers with a system or when a device powers on. Different devices have different device characteristics and in many instances will have information that is unique per individual device allowing for unique device identification and generating device match data and encryption keys. In numerous embodiments, the device match data can be combined with random data and/or processed by a key derivation function to avoid predictability in encryption keys. In many embodiments, several device characteristics are represented by information about the device that can be obtained from the device or its hardware or software components. Device characteristics can include (but are not limited to) a Media Access Control (MAC) address stored on the device's network interface card (NIC), serial numbers built into chips on the device, serial numbers or license keys of the operating system, BIOS IDs, and product IDs. In several embodiments, each class of playback device or different product has the ability to generate device match data using a different set of device characteristics. In many embodiments, the device protection key 407 is utilized to protect information such as DRM certificate(s) 416 and device robustness information 414. In various embodiments, the device protection key can be utilized to create an encrypted memory 412 within the non-volatile memory 408 by encrypting a block of memory containing information including the device robustness information 414 and/or DRM certificates.

The non-volatile memory 408 can also be utilized to store a client application 410 to configure the playback device use a network interface 418 to enable a user to select content via the content store, obtain licenses to the content from the DRM server, and access content on the content distribution server. In additional, the client application can utilize the licenses and the DRM certificates to decrypt encrypted content received from the content distribution server and decode the content for playback. In many embodiments, the client application can utilize the robustness information to verify device robustness. In one embodiment, the playback device can send robustness information to the content store to assist the content store in determining whether to issue content. In various embodiments, the device can communicate with the content store using a DRM client code, where the content store may decide to only display content for rent or purchase that meets the robustness level of the device associated with the DRM client code. In another embodiment, the playback device provides the robustness information to the DRM server. In such embodiments, the content store can provide a robustness request to the DRM server and the DRM server informs the store whether the device is sufficiently robust. In a still further embodiment, the device itself determines whether it is sufficiently robust to playback content as further discussed below.

Although specific configurations of servers and playback devices are discussed above with respect to FIGS. 2-4, any of a variety of configurations of playback devices and serves can be utilized as appropriate to the requirements of a specific application in accordance with embodiments of the invention. Processes for restricting access to content by verifying device robustness in accordance with embodiments of the invention are further discussed below.

### Verifying Device Robustness

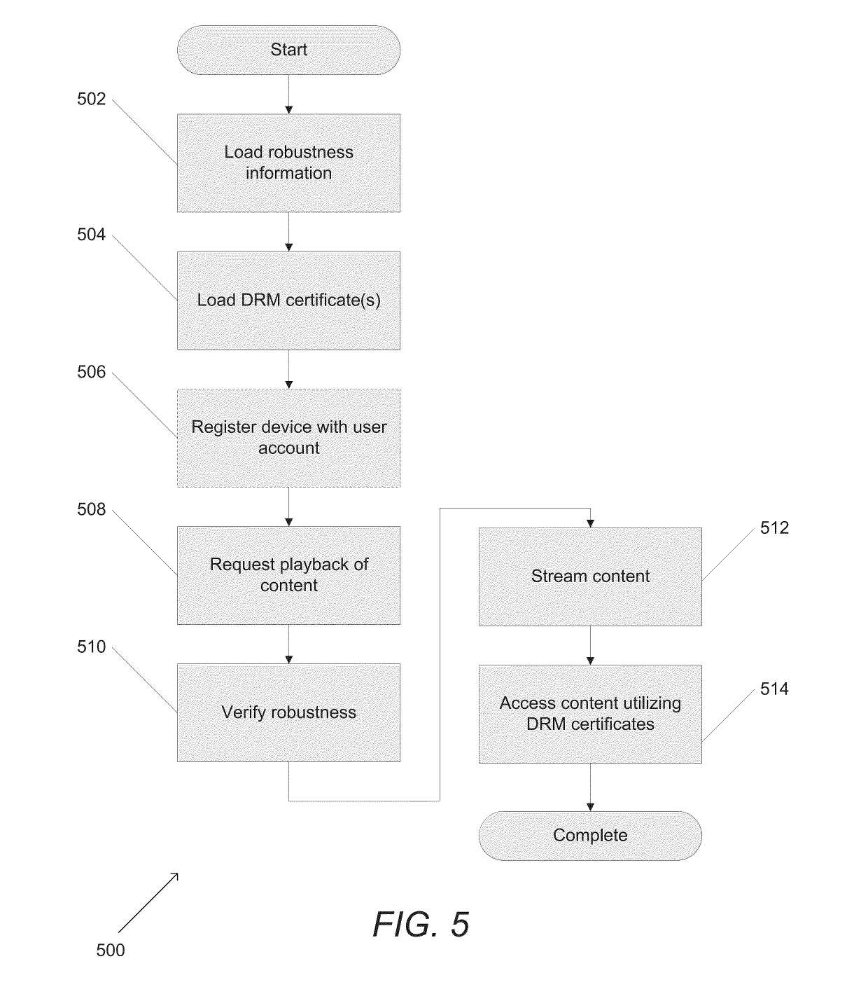

Device playback capabilities and DRM are typically implemented on a device using software. The robustness of a device to resist or prevent attempts to compromise the DRM typically depends on the device manufacturer and different devices running the same software may have different levels of robustness. A process for verifying robustness of a device in accordance with an embodiment of the invention is shown in FIG. 5. The process 500 includes loading (502) device robustness information where the robustness information is often stored in encrypted memory within the device. The process also includes loading (504) one or more DRM certificates that can be utilized to authenticate playback devices to a DRM server. In many embodiments, DRM certificates can be part of a DRM system including (but not limited to) the DRM systems described in U.S. patent application Ser. No. 13/339,315, entitled “Binding of Cryptographic Content using Unique Device Characteristics with Server Heuristics”, filed Dec. 28, 2011, the disclosure of which is incorporated by reference above. In many embodiments, the DRM server can transmit cryptographic data (including DRM certificates) to the playback device at registration of the device with a DRM server. The cryptographic data can be stored using a cryptographic key generated using data collected by the device concerning characteristics of the device known as device match data where the device match data is used to uniquely identify the device to the DRM server. Further, the device match data can be used to generate a device protection key that can be utilized to protect and/or encrypt the cryptographic data stored in the non-volatile memory of the device as discussed above. The process 500 may also include registering (506) the device with a user account that can add functionality including (but not limited to) associating multiple devices to a single user account and/or allowing for easier authentication in future sessions.

In various embodiments, a device can request (508) playback of content from a content store where device robustness is first verified (510) before the device is granted access to the content as further discussed below. The verification can occur at the content store server or at the device and typically includes comparing a device robustness level found in the robustness information to a robustness threshold that is predetermined by a content provider. If the device robustness is verified to be adequate, the requested content is streamed (512) and/or otherwise provided to the playback device from the content distribution server. Content streaming and/or delivery can be implemented in a manner well known to one of ordinary skill in the art. Once robustness is verified and the content delivered to the device, the device can utilize the DRM certificates received from the DRM server to access (514) the content.

Although specific processes for restricting access to content using a robustness framework are discussed above with respect to FIG. 5, any of a variety of processes for restricting access to content utilizing a robustness framework as appropriate to the requirements of a specific application can be utilized in accordance with embodiments of the invention. Processes for setting device robustness levels in accordance with embodiments of the invention are further discussed below.

### Setting Device Robustness Information to a Playback Device

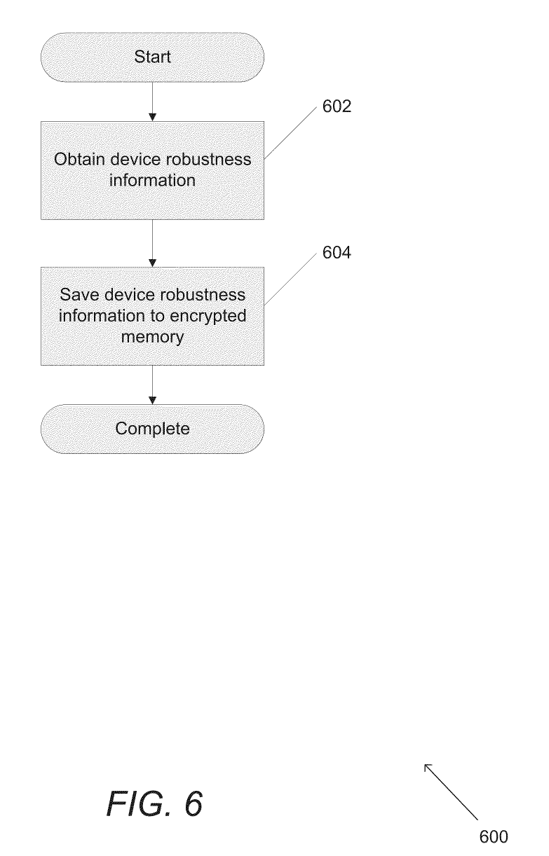

Device robustness information can include a device robustness level that the device has achieved in relation to a set of predetermined robustness rules where the robustness rules can be defined by a content provider and/or a content store. A process for setting device robustness information on a playback device in accordance with an embodiment of the invention is illustrated in FIG. 6. The process 600 includes obtaining (602) the device robustness information. In many embodiments, the device robustness information is provided by the device manufacturer after the manufacturer has evaluated the device using measurement criteria as defined by the robustness rules. Once the device robustness information is obtained, it can be saved (604) to an encrypted memory within the non-volatile memory of the device. In several embodiments, a device protection key is utilized to create the encrypted memory by encrypting a block of memory containing information including the device robustness information. In some embodiments, the encrypted memory can be achieved using special purpose hardware that restricts access. Although specific processes for setting device robustness information ton encrypted memory are discussed above with respect to FIG. 6, any of a variety of processes for setting device robustness information to encrypted memory as appropriate to the requirements of a specific application can be utilized in accordance with embodiments of the invention. Processes for setting threshold robustness in accordance with embodiments of the invention are discussed further below.

### Embedding Threshold Robustness in a Content License

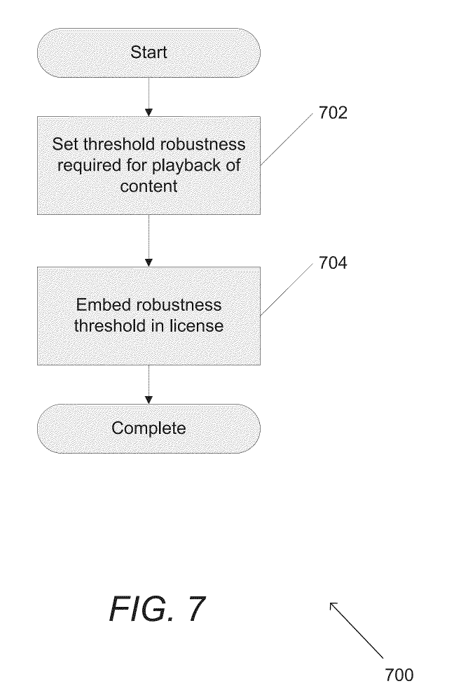

As discussed above, content can be encrypted using one or more encryption keys and a DRM server can generate a content license using the encryption keys utilized in encrypting the content. Further, the robustness threshold can be embedded in a content license. A process for embedding threshold robustness in a content license in accordance with an embodiment of the invention is illustrated in FIG. 7. The process 700 includes the content provider setting (702) a threshold robustness for accessing the content. In many embodiments, the content provider can dynamically change the threshold robustness as discussed above. Further, the content provider may consult the content store in setting the threshold robustness. In several embodiments, the threshold robustness is embedded (704) in a content license as discussed above including utilizing a DRM server. In many embodiments, the content and the content license are stored in separate servers and can be transmitted to a playback device independently of each other. Although specific processes for embedding threshold robustness in a content license are discussed above with respect to FIG. 7, any of a variety of processes for embedding threshold robustness in a content license as appropriate to the requirements of a specific application can be utilized in accordance with embodiments of the invention. Processes for verifying device robustness at a content store server in accordance with embodiments of the invention are discussed further below.

### Verifying Device Robustness at the Content Store

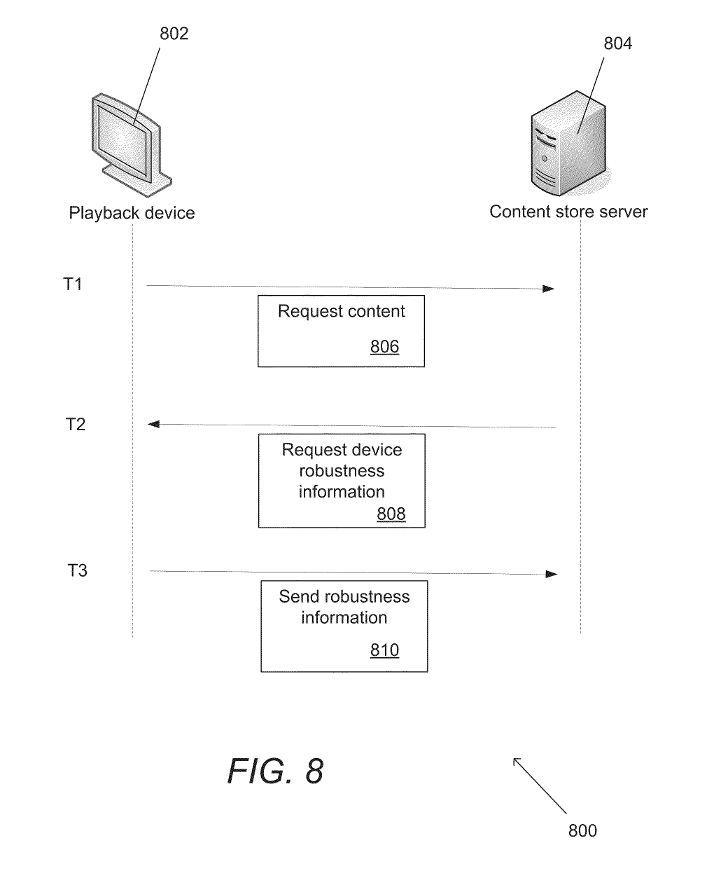

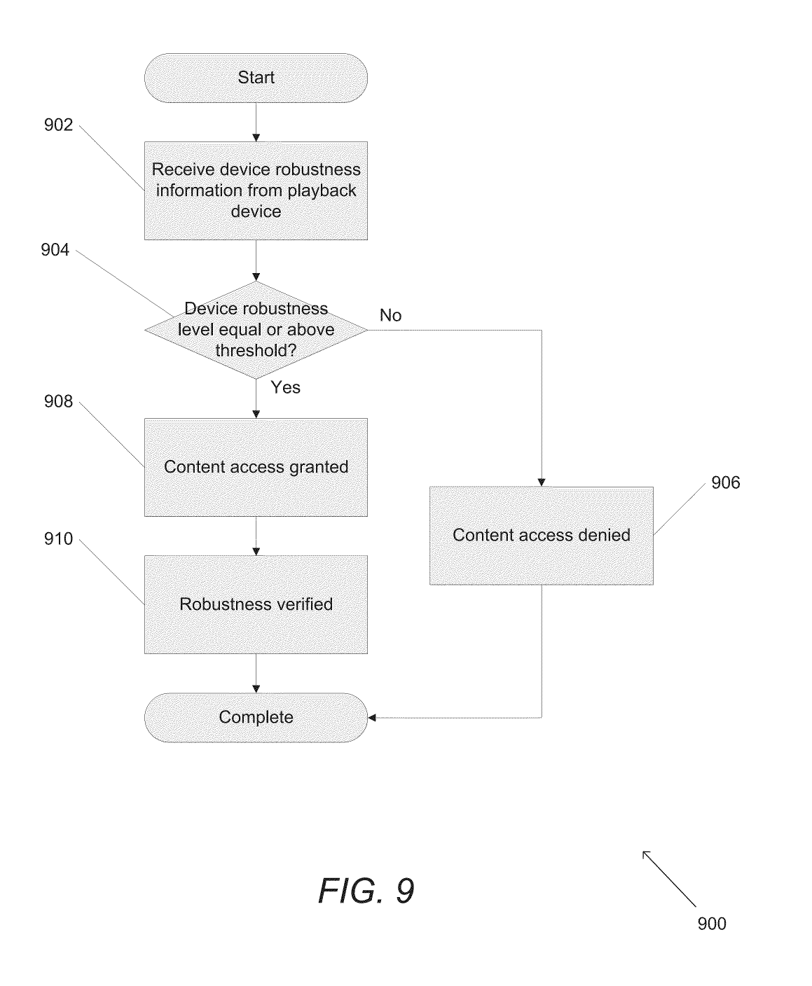

A device robustness level can be verified at a content store server, DRM server and/or at a playback device. Verifying device robustness at a content provider server in accordance with an embodiment of the invention is shown in FIGS. 8 and 9. A diagram illustrating communications between a playback device and a content store in verifying device robustness at the content store server in accordance with an embodiment of the invention is illustrated in FIG. 8. The diagram 800 includes a playback device 802 in network communication with a content store server 804. In one embodiment, at a time T₁ the playback device requests (806) content from the content store server. Upon receiving the request, the content store server can request (808) device robustness information from the playback device at a later time T₂ in order to verify that the device is sufficiently secure to access the requested content. The playback device can then send (810) its robustness information to the content store server at a still later time T₃ where verification is performed as discussed below. Although a specific time sequence of communications between the playback device and content stores server is discussed above, in other embodiments the sequence of the communications can be modified as appropriate to the requirements of specific applications. In some embodiments, the server may not request the robustness information. In various embodiments, the playback device can send its robustness information without the content store first requesting for it and the device can transmit its robustness information simultaneously or separately from the content request.

A process of verifying device robustness at a content provider server in accordance with an embodiment of the invention is further shown in FIG. 9. The process 900 includes the content provider server receiving (902) device robustness information from a playback device as described above. In verifying the device robustness, a determination is made (904) as to whether the device robustness level is equal to or greater than the robustness threshold. If the device robustness is below the threshold robustness, then content access is denied (906). However, if the device robustness level is equal to or greater than the threshold robustness, then content access is granted (908) and device robustness is verified (910). Although specific processes for verifying device robustness at a content provider server are discussed above with respect to FIGS. 8 and 9, any of a variety of processes for verifying device robustness at a content provider server as appropriate to a specific application can be utilized in accordance with embodiments of the invention. Further, similar verifications processes can be performed other servers including (but not limited to) DRM servers. Processes for verifying device robustness at a playback device in accordance with embodiments of the invention are discussed further below.

### Verifying Device Robustness at the Playback Device

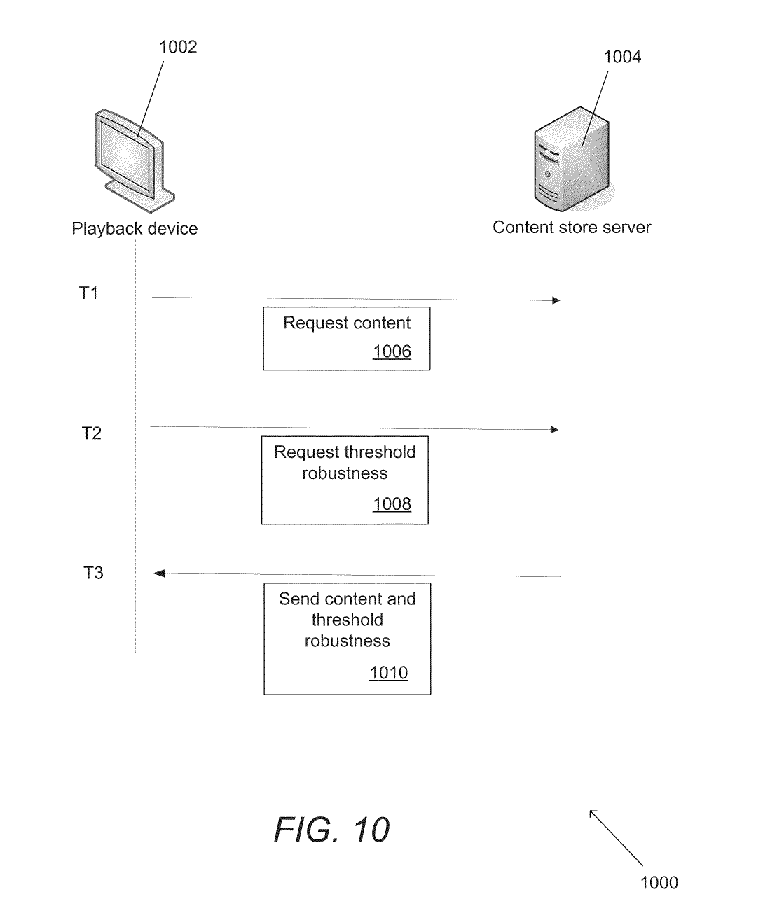

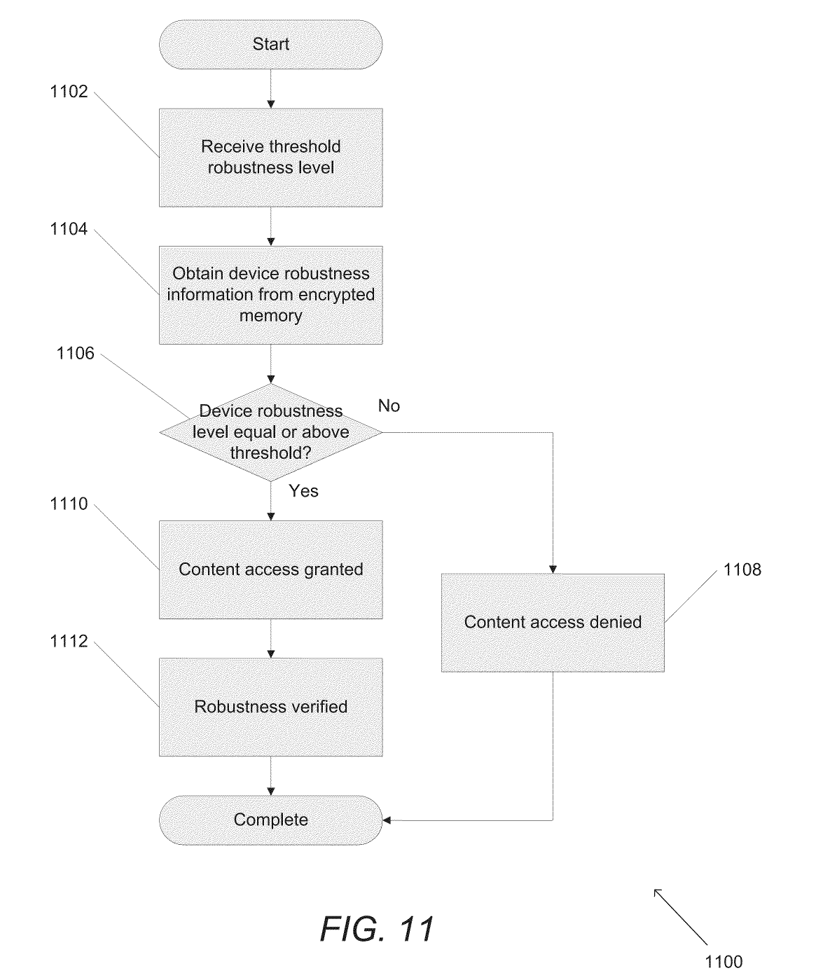

Device robustness can also be verified at a playback device. Verifying device robustness at a playback device in accordance with an embodiment of the invention is shown in FIGS. 10 and 11. A diagram illustrating communications between a playback device and a content store server in verifying device robustness at the playback device in accordance with an embodiment of the invention is illustrated in FIG. 10. The diagram 1000 includes a playback device 1002 in network communication with a content store server 1004. At a time T₁, the playback device requests (1006) content from a content store server. In many embodiments, the playback device also sends a request (1008) for the threshold robustness from the content server at a later time T₂. The content store server then sends (1010) the content and/or the threshold robustness to the playback device at a still later time T₃ where verification is performed at the device as discussed below. Although a specific time sequence of communications between the playback device and content stores server is discussed above, in other embodiments the sequence of the communications can be modified as appropriate to the requirements of specific applications. In some embodiments, the playback device can simultaneously request both the content and the threshold robustness from the content store server. In various embodiments, the playback device can receive a license embedded with the threshold robustness from a DRM server. In many embodiments, the content store server instructs the DRM server to send the license at some point after receiving a request 1006 for content from the playback device.

A process for verifying device robustness at a playback device in accordance with an embodiment of the invention is illustrated in FIG. 11. The process 1100 includes a playback device receiving (1102) the threshold robustness level. In many embodiments, the threshold robustness can be marked on the content or embedded in a license. The playback device obtains (1104) the device robustness information from its encrypted memory in manner well known to one of ordinary skill in the art. With both the threshold robustness and the device robustness level, a determination is made (1106) as to whether the device robustness level is equal to or above the threshold robustness. If the device robustness level is below the threshold robustness, then access to the content is denied (1108). However, if the device robustness level is equal or above the threshold robustness, then content access is granted (1110) and the device robustness has been verified (1112). Although specific processes for verifying device robustness at a playback device are discussed above with respect to FIGS. 10 and 11, any of a variety of processes for verifying device robustness at a playback device as appropriate to a specific application can be utilized in accordance with embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A method of restricting access to digital content utilizing a set of robustness rules comprising:
loading device robustness information, where the device robustness information includes a device robustness level defined using a set of robustness rules;
loading at least one digital rights management (DRM) certificate, where the at least one DRM certificate is utilized to authenticate the device to a DRM server;
requesting playback of the content from a content store, where the content store is configured to store the content in at least one content distribution server;
receiving the content from the at least one content distribution server upon a verification that the device robustness satisfies a threshold robustness by a computing system, where the threshold robustness is predetermined by a content provider; and
accessing the received content utilizing the at least one DRM certificate.

2. The method of claim 1, wherein the device robustness level is verified when the device robustness level is greater than the threshold robustness.

3. The method of claim 1, wherein the device robustness level is verified when the device robustness level is equal to the threshold robustness.

4. The method of claim 1, wherein the device robustness level is not verified when the device robustness level is less than the threshold robustness.

5. The method of claim 1, wherein the computing device that verifies that the device robustness level satisfies the predetermined threshold robustness is a remote server.

6. The method of claim 1, wherein the computing device that verifies that the device robustness level satisfies the predetermined threshold robustness is the playback device.

7. The method of claim 1, wherein the content has an associated license that is embedded with the robustness threshold.

8. The method of claim 1, wherein loading at least one digital rights management (DRM) certificate further comprises the DRM server transmitting the at least one DRM certificate to the playback device at registration of the device with the DRM server.

9. The method of claim 1, wherein the device robustness information is stored in an encrypted memory on the playback device.

10. The method of claim 9, wherein the memory is encrypted using a device protection key generated using device match data where the device match data can include device characteristics.

11. The method of claim 1, wherein the set of robustness rules is defined utilizing Federal Information Processing Standards.

12. A playback device comprising:
a processor;
a memory containing a client application that configures the processor to:
load device robustness information, where the device robustness information includes a device robustness level defined using a set of robustness rules;
load at least one digital rights management (DRM) certificate, where the at least one DRM certificate is utilized to authenticate the device to a DRM server;
request playback of the content from a content store, where the content store is configured to store the content in at least one content distribution server;
receive the content from the at least one content distribution server upon a verification that the device robustness satisfies a threshold robustness by a computing system, where the threshold robustness is predetermined by a content provider; and
access the received content utilizing the at least one DRM certificate.

13. The playback device of claim 12, wherein the device robustness level is verified when the device robustness level is greater than the threshold robustness.

14. The playback device of claim 12, wherein the device robustness level is verified when the device robustness level is equal to the threshold robustness.

15. The playback device of claim 12, wherein the device robustness level is not verified when the device robustness level is less than the threshold robustness.

16. The playback device of claim 12, wherein the computing device that verifies that the device robustness level satisfies the predetermined threshold robustness is a remote server.

17. The playback device of claim 12, wherein the computing device that verifies that the device robustness level satisfies the predetermined threshold robustness is the playback device.

18. The playback device of claim 12, wherein the content has an associated license that is embedded with the robustness threshold.

19. The playback device of claim 12, wherein loading at least one digital rights management (DRM) certificate further comprises the DRM server transmitting the at least one DRM certificate to the playback device at registration of the device with the DRM server.

20. The playback device of claim 12, wherein the device robustness information is stored in an encrypted memory on the playback device.

21. The playback device of claim 20, wherein the memory is encrypted using a device protection key generated using device match data where the device match data can include device characteristics.

22. The playback device of claim 12, wherein the set of robustness rules is defined utilizing Federal Information Processing Standards.

23. A machine readable medium containing processor instructions, where execution of the instructions by a processor causes the processor to perform a process comprising:
loading device robustness information, where the device robustness information includes a device robustness level defined using a set of robustness rules;
loading at least one digital rights management (DRM) certificate, where the at least one DRM certificate is utilized to authenticate the device to a DRM server;
requesting playback of the content from a content store, where the content store is configured to store the content in at least one content distribution server;
receiving the content from the at least one content distribution server upon a verification that the device robustness satisfies a threshold robustness by a computing system, where the threshold robustness is predetermined by a content provider; and
accessing the received content utilizing the at least one DRM certificate.
